(19) United States
(12) Patent Application Publication
(10) Pub. No.: US 2018/0173317 A1
(43) Pub. Date: Jun. 21, 2018

(54) SYSTEM AND METHOD FOR SHARING DATA-CONTENT BETWEEN APPLICATIONS

(71) Applicant: FastFingers Oy, Helsinki (FI)

(72) Inventors: Juho Kinnunen, Oulu (FI); Janne Takalo, Kalajoki (FI)

(21) Appl. No.: 15/737,369

(22) PCT Filed: May 4, 2016
(86) PCT No.: PCT/FI2016/050288

§ 371 Date: Dec. 18, 2017

Related U.S. Application Data
(60) Provisional application No. 62/181,427, filed on Jun. 18, 2015.

(51) Int. Cl. G06F 3/01; G06F 3/0486; G06F 3/0488; G06F 17/30

(52) U.S. Cl. CPC G06F 3/017; G06F 3/0486; G06F 9/54; G06F 17/30165; G06F 3/04883

(57) ABSTRACT

A method for sharing data-content between applications on a display of a computing device. The method includes providing an application to be currently displayed on the display of the computing device; selecting a data-content from the currently displayed application upon recognizing a pre-determined activation gesture; presenting at least one user-interface-icon associated with at least one application, other-than the currently displayed, on the display of the computing device; and sharing the selected data-content from the currently displayed application to an application associated with a user-interface-icon selected from the at least one user-interface-icon.

### TECHNICAL FIELD

The present disclosure relates generally to sharing data-content between applications; and more specifically, to a method and a system for sharing data-content between applications on a display of a computing device.

### BACKGROUND

An application, such as a merchant's website, a social-media website or a chatting application, offers a variety of data-content. For example, the data-content may include but is not limited to images, audio files, video files, contact details, location, document files, application files and web-links. Typically, an individual browses such applications on a computing device, such as a smart phone, for assessing the data-content of the applications. Further, the individual can share the data-content of one application with another application. For example, an individual browsing a merchant's website can share data-content (such as any sale offer) from the merchant's website to a social-media website to inform other individuals associated with the social-media website. Alternatively, an individual browsing a social-media website can share data-content (such as an image or a web-link) from the social-media website to a chatting application for being received by a friend of the individual.

Typically, such sharing of the data-content between applications is a cumbersome task. Specifically, conventional sharing of data-content between applications includes various intermediate steps. For example, while sharing a data-content, the data-content may be copied, saved and routed through different paths in a computing device by selecting different user-interface-icons. Additionally, the applications may be switched for sharing of the data-content there-between. In such instance, the problem associated with conventional sharing can be addressed by providing each application a separate sharing functionality. However, such separate sharing functionality would require extra coding in architecture/design level for each application causing an increase in their coding size and complexity.

Therefore, in light of the foregoing discussion, there exists a need to overcome the aforementioned drawbacks of sharing data-content between the applications.

### SUMMARY

The present disclosure seeks to provide a method for sharing data-content between applications on a display of a computing device.

The present disclosure also seeks to provide a computing device for sharing data-content between applications on a display thereof.

The present disclosure also seeks to provide a system for sharing data-content between applications.

In one aspect, an embodiment of the present disclosure provides a method for sharing data-content between applications on a display of a computing device. The method comprises:

providing an application to be currently displayed on the display of the computing device;

selecting a data-content from the currently displayed application upon recognizing a pre-determined activation gesture;

presenting at least one user-interface-icon associated with at least one application, other-than the currently displayed, on the display of the computing device; and

sharing the selected data-content from the currently displayed application to an application associated with a user-interface-icon selected from the at least one user-interface-icon.

In an example, the computing device may include but is not limited to smartphones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers and large-sized touch screens with embedded PCs. In an example, the computing device beneficially has a touch based input device. Typically, the computing device includes a communication module and a processor that makes the computing device compatible for web-based communication, for example the computing device s operable for accessing the applications and sharing data-content there-between.

Optionally, the method further comprises:

rendering a destination-list associated with the application based on the selected user-interface-icon; and

sharing the selected data-content with at least one destination selected from the destination-list.

Optionally, the pre-determined activation gesture comprises one of long press on the display, multiple-tap on the display, force-touch and shaking the computing device. The long press is defined to last at least 0.2 seconds. Alternatively, the pre-determined activation gestures may be performed for discarding a selection of the data-content.

Alternatively, the method further comprises:

rendering a drop-zone for dropping the selected data-content from the currently displayed application therein, prior to presenting the at least one user-interface-icon on the display of the computing device.

Optionally, the data-content comprises one of an image, an audio file, a video file, a contact record, location, document file, application file and a web address. In one embodiment, the application may include but not be limited to a merchant's website, a social-media website, a chatting application or any other web based application that offers a variety of data-content.

In another aspect, an embodiment of the present disclosure provides a computing device for sharing data-content between applications on a display of the computing device, the computing device comprising a processor operable to:

provide an application to be currently displayed on the display of the computing device;

select a data-content from the application upon recognizing a pre-determined activation gesture;

present at least one user-interface-icon associated with at least one application, other-than the currently displayed, on the display of the computing device; and

share the selected data-content from the currently displayed application to an application associated with a user-interface-icon selected from the at least one user-interface-icon.

In yet another aspect, an embodiment of the present disclosure provides a system for sharing data-content between applications, the system comprising a source server, at least one destination server and a computing device communicably coupled to the source server and the at least one destination server. The computing device comprises a processor operable to:

provide an application from the source server to be currently displayed on the display of the computing device;

select a data-content from the application upon recognizing a pre-determined activation gesture;

present at least one user-interface-icon associated with at least one application, of the at least one destination server on the display of the computing device; and

share the selected data-content from the currently displayed application of the source server to an application associated with a user-interface-icon selected from the at least one user-interface-icon.

In an embodiment the data-content is locally available in the device. An example of such data content is image captured with the computing device. In such a case, the source server is rather an application or server in the computing device.

In another embodiment the destination server is an application resident in the device. An example of such an application is the image gallery generally available in smartphones and the like.

In another embodiment the destination server is an application on a second computing device, the application providing peer-to-peer communication functionality.

According to an embodiment of the present disclosure, the system comprises more than one destination server, such as two, three, four, five, six or more destination servers.

It may be evident to those skilled in the art that the source server may also act as a destination server (i.e. with which a selected data-content can be shared); and the destination servers may act as a source server (i.e. from which a data-content can be selected for sharing). In an example, the source server can be a server of an online merchant, such as Amazon, Flip-cart and the like, providing an online merchant website (or portal). Further, the destination servers can be a server of a social-media service provider, such as WhatsApp, Instagram, Facebook, and Viber, providing online social-media websites. Alternatively, the destination servers can be a server of a chatting service provider, such as Skype and Google Hangout. (Device contacts, photos, videos, files, mails?)

In one embodiment, the system may also include an application server (not shown), communicably coupled to the computing device, operable for accessing the applications from the source server and the destination servers and sharing data-content there-between through the computing device. In such instance, the application server is communicably coupled to the source server and the destination servers for sharing data-content through the computing device. Further, the application server and the computing device is compatible with all modern operating systems like Android, iOS, Windows and the like.

The computing device is communicably coupled to the source server and the destination servers by a communication network. The communication network can be a wired, wireless, or a combination thereof. Examples of such communication network includes, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAX) networks.

In an embodiment, the computing device, i.e. the smart phone may be a Samsung Galaxy Note Edge, in such instance, the sharing of the data-content between the applications may be performed on a side-screen arranged on an edge of the Samsung Galaxy Note Edge.

In an example, an individual using an Android based smart phone (i.e. the computing device) for accessing a website of Amazon (currently displayed application) on a display of the smart phone. Further, while accessing Amazon the individual come across a data-content (in the form of an image, a link, or a data-content with an embedded link), such as a sale-offer on any particular product, which the individual feels worth sharing with other individuals. In such instance, the individual performs the pre-determined activation gesture, such as the long press or force-touch, on the image of sale-offer provided by Amazon for the selection thereof. Upon selecting the image a translucent image or a thumbnail image of the selected image is rendered on top of the selected image. Further, upon selecting the image at least one user-interface-icon associated with at least one application, other-than the currently displayed, is presented on the display of the smart phone. For example, the at least one application may include WhatsApp, Instagram, Twitter and the like. The individual may select a user-interface-icon associated with WhatsApp for sharing the data-content (i.e. the image for the sale-offer given by Amazon) with other individuals (such as friends and colleagues) connected with the individual through WhatsApp. Specifically, upon selecting the user-interface-icon associated with WhatsApp a destination list having a plurality of destinations (such as friends and colleagues contacts) is presented on the display of the smart phone. Finally, the individuals selects at least one destination (i.e. friends and colleagues), with whom he/she wants to share the image for the sale-offer given by Amazon. This allows the individual to share data-content (the image for the sale-offer) between the applications, such as the Amazon (source server) and WhatsApp (destination server). Similarly, the individual can share data-content (such as images, audio files, video files and web addresses) between the applications, such as from Facebook (source server) to WhatsApp (destination server). Additionally, the individual can share data-content between the applications, such from a Google website (source server) to Skype (destination server), a chatting website.

Embodiments of the present disclosure substantially eliminate or at least partially address the aforementioned problems in the prior art, and enables easy and efficient sharing of data-content between applications on a display of a computing device.

Additional aspects, advantages, features and objects of the present disclosure would be made apparent from the drawings and the detailed description of the illustrative embodiments construed in conjunction with the appended claims that follow.

The present disclosure provides a method, a computing device and a system for sharing a data-content between applications. Specifically, the present disclosure enables in efficiently sharing the data-content (between applications) on a display of the computing device. For example, the present disclosure enables in eliminating various intermediate steps, such as copying and/or saving a data-content, routing the data-content through different paths and switching between the applications, while sharing the data-content between the applications. Moreover, the present disclosure precludes a need for providing a separate sharing functionality, to each application for sharing data-content there-between, and thereby reducing coding size and complexity for such applications.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for sharing data-content between applications, in accordance with an embodiment of the present disclosure;

FIG. 2 is a schematic illustration of a computing device having a display shown with an application provided by a source server, in accordance with an embodiment of the present disclosure;

FIG. 3 is a schematic illustration of the computing device with the display shown with a plurality of user-interface-icons, in accordance with an embodiment of the present disclosure;

FIG. 4 is a schematic illustration of the computing device with the display shown with a destination list, in accordance with an embodiment of the present disclosure;

FIG. 5 is a schematic illustration of the computing device with the display shown with a drop-zone, in accordance with another embodiment of the present disclosure;

FIG. 6 is a schematic illustration of the computing device with the display shown with a list of plurality of applications, in accordance with an embodiment of the present disclosure;

FIG. 7 is an illustration of steps of a method for sharing data-content between applications on a display of a computing device, in accordance with an embodiment of the present disclosure; and

FIG. 8 illustrates the software architecture of the computing device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

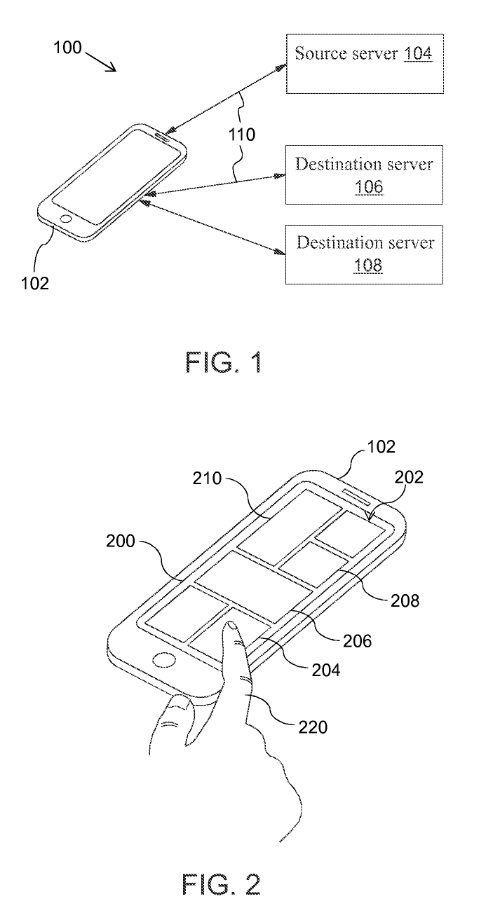

Referring to FIG. 1, illustrated is a schematic illustration of a system 100 for sharing data-content between applications, in accordance with an embodiment of the present disclosure. The system 100 includes a computing device 102, a source server 104 and at least one destination server, in this embodiment two destination servers 106, 108. The system 100 of the present disclosure enables sharing of a data-content between the applications on a display of the computing device 102, as explained in further detail hereinafter.

The source server 104 and the destination servers 106, 108 are associated with such applications. Specifically, the source server 104 is associated with an application from where the data-content is to be selected for sharing, whereas the destination servers 106, 108 are associated with applications with which the selected data-content is to be shared. In the present embodiment, the computing device 102 is operable to access the application therein. The computing device 102 is communicably coupled to the source server 104 and the destination servers 106, 108 by a communication network 110.

In an embodiment the data-content is locally available in the device. An example of such data content is image captured with the computing device 102. In such a case, the source server 104 is rather an application or server in the computing device 102.

In operation, the processor of the computing device 102 is configured to provide content from the source server 104 to be currently displayed on a display of the computing device 102. Specifically, the computing device 102 requests content from the source server 104 for rendering the content on the display of the computing device 102. In an embodiment the content may be web content, comprising text, pictures, script programs and so forth. Further, the processor is operable to select a data-content from the application upon recognizing a pre-determined activation gesture (explained in more detail herein later). Specifically, the processor of the computing device 102 is operable to recognise the pre-determined activation gesture of a user (associated with the computing device 102) for selecting a data-content from the application. For example, the processor selects the data-content and thereby receives the data type and meta-data of the data-content from the source server 104.

Thereafter, the processor of the computing device 102 (or the application server) is configured to present at least one user-interface-icon associated with the sharing functionality, further associated with at least one application, of the at least one destination server 106, 108, on the display of the computing device 102. Further, the selected data-content from the currently displayed application of the source server 104 is shared with an application associated a user-interface-icon selected from the at least one user-interface-icon.

In one embodiment, a destination-list associated with the application based on the selected user-interface-icon is rendered on the display of the computing device 102. Finally, the selected data-content is shared with at least one destination selected from the destination-list. For example, the destination-list is a list of user contacts, such as friends, colleagues and the like.

In one embodiment showing the destination-list is optional. This is specifically applicable to sharing services like Twitter, where the content is shared with all users of the service.

In another embodiment, the processor of the computing device 102 (or the application server) is configured to render a drop-zone for dropping the selected data-content from the currently displayed application therein, prior to presenting the at least one user-interface-icon on the display of the computing device 102. Thereafter, a list of user-interface-icon associated with at least one application, of the at least one destination server 106, 108, is presented on the display of the computing device 102. This further allows rendering a destination-list and sharing the selected data-content with at least one destination selected from the destination-list.

Referring now to FIG. 2, illustrated is a schematic illustration of the computing device 102 having a display 200 shown with an application 202 with content provided by a source server (such as the source server 104 (102?) shown in FIG. 1), in accordance with an embodiment of the present disclosure. As shown, the application 202 includes (or offers) various type of data-contents, such as data-contents 204, 206, 208 and 210. An individual can select a data-content from the data-contents 204, 206, 208 and 210 of the currently displayed application 202 (provided on the display 200 of the computing device 102). In an embodiment, the application 202 is a web-program. In another embodiment the application 202 is a native application.

Further, as shown, the individual uses his/her finger 220 for selecting a data-content, such as the data-content 204, from the currently displayed application 202. As mentioned above, the processor of the computing device 102 is operable to recognize a pre-determined activation gesture of the individual for selecting the data-content 204. Specifically, each of the pre-determined activation gesture is registered with the processor of the computing device 102, such that when the individual performs such pre-determined activation gesture the data-content 204 is selected from the currently displayed application 202.

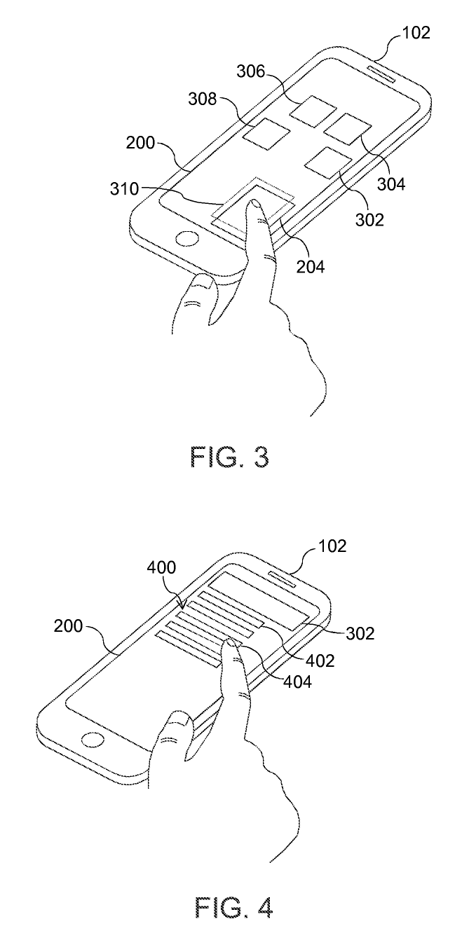

Referring now to FIG. 3, illustrated is schematic illustration of the computing device 102 with the display 200 shown with a plurality of user-interface-icons, in accordance with an embodiment of the present disclosure. Specifically, the display 200 of the computing device 102 is shown with the plurality of user-interface-icons, such as user-interface-icons 302, 304, 306 and 308, associated with applications other than the currently displayed application 202 of FIG. 2. The plurality of user-interface-icons 302, 304, 306 and 308 are rendered on the display 200 of the computing device 102 soon after selecting the data-content 204.

Further, shown is a translucent image (or thumbnail) 310 on top of the selected data-content 204 formed when the pre-determined activation gesture is performed on the data-content 204 for the selection thereof. The translucent image 310 may be guided or moved towards one of the user-interface-icons 302, 304, 306 and 308 for selecting a user-interface-icon therefrom. Specifically, the selected data-content 204 is shared from the currently displayed application 202 (shown in FIG. 2) to an application associated with a user-interface-icon selected from the user-interface-icon 302, 304, 306 and 308. For example, the translucent image 310 of the selected data-content 204 may be guided towards the user-interface-icon 302 for sharing the selected data-content 204 from the currently displayed application 202 to an application associated with the user-interface-icon 302.

Referring now to FIG. 4, illustrated is a schematic illustration of the computing device 102 with the display 200 shown with a destination-list 400, in accordance with an embodiment of the present disclosure. Specifically, the destination-list 400 is associated with the application, other-than the currently displayed application 202 (shown in FIG. 2), based on the selected user-interface-icon 302. The destination-list 400 includes a plurality of destinations, such as destinations 402 and 404. As shown, the individual selects a destination 404 for finally sharing the selected data-content 204 (shown in FIG. 3) from the currently displayed application 202 (shown in FIG. 2) with at least one destination, such as the destination 404, selected from the destination-list 400. The individual may select the destination 404 by simply tapping on the destination 404.

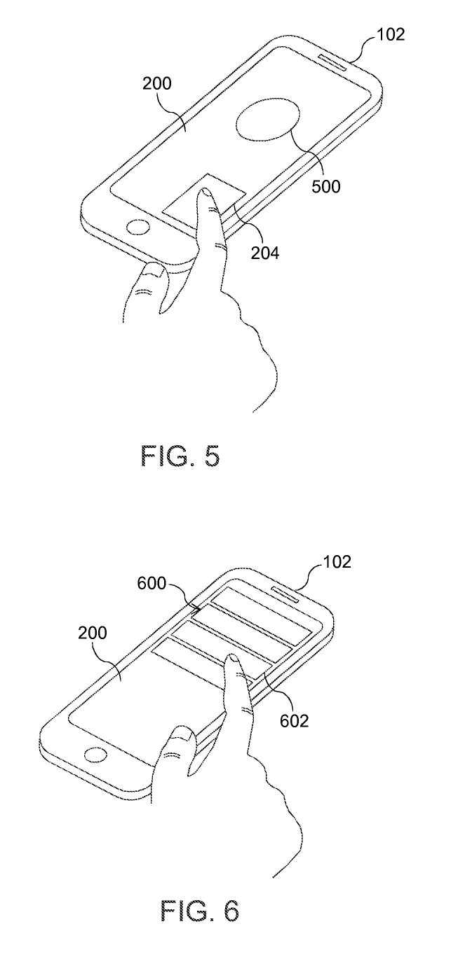

Referring now to FIG. 5, illustrated is a schematic illustration of the computing device 102 with the display 200 shown with a drop-zone 500. Specifically, in one embodiment, upon selecting a data-content, such as the data-content 204, from the currently displayed application 202 (shown in FIG. 2) the drop-zone 500 is rendered on the display 200 of the computing device 102 for dropping the selected data-content 204 therein. For example, the drop-zone 500 acts a storage that collects and temporarily stores the selected data-content 204 therein. In one embodiment, the drop-zone 500 may be used for collecting and temporarily storing multiple data-contents at the same time. Further, a translucent image (such as the translucent image 310, shown in FIG. 3) may be rendered on top of the selected data-content 204 of FIG. 5. The translucent image may be guided or moved towards the drop-zone 500 for dropping the selected data-content 204 therein.

The visualization of the data content may optionally be a thumbnail image.

Referring now to FIG. 6, illustrated is a schematic illustration of the computing device 102 with the display 200 shown with a list of plurality of applications 600, in accordance with an embodiment of the present disclosure. Specifically, the list of plurality of applications 600 is rendered on the display 200 when the selected data-content 204 is dropped the drop-zone 500. Further, the list of plurality of applications 600 is associated with destination servers, such as destination servers 106, 108 (shown in FIG. 1). Moreover, the list of plurality of applications 600 includes applications, other than the application, such as the application 202 (shown in FIG. 2) currently displayed on the display 200 of the computing device 102. As shown, the individual selects an application 602 from the list of plurality of applications 600 for sharing the selected data-content 204 which may be dropped in the drop-zone 500 (shown in FIG. 5). The individual may select the application 602 by simply tapping on the application 602. Further, once the data-content 204 is shared with the destination associated with the selected application 602, the individual is redirected back to the application 202 (shown in FIG. 2). This avoids switching of the applications for sharing of the data-content 204.

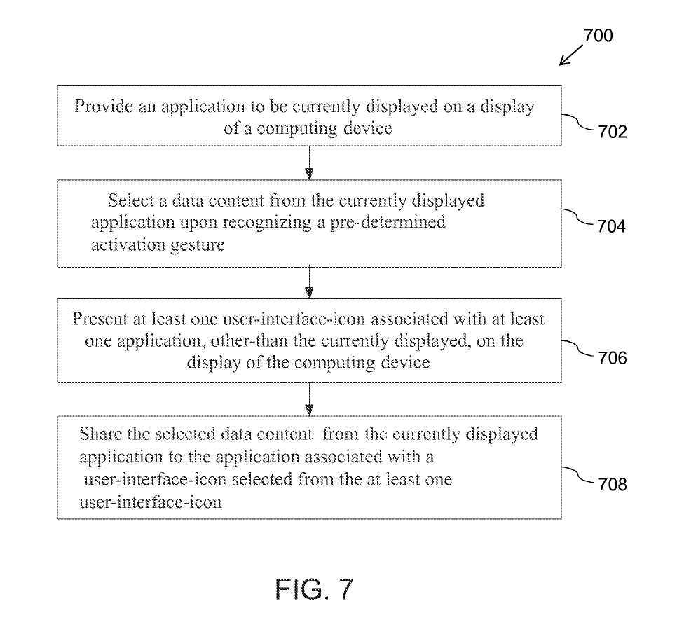

Referring now to FIG. 7, illustrated are steps of a method 700 for sharing the data-content between the applications, in accordance with an embodiment of the present disclosure. Specifically, those skilled in the art would recognize that the method 700 illustrates steps involved in the operation of the system 100, explained in conjunction with the FIGS. 1-6.

At step 702, an application is provided to be currently displayed on a display of a computing device.

At step 704, a data-content is selected from the currently displayed application upon recognizing a pre-determined activation gesture.

At step 706, at least one user-interface-icon associated with at least one application, other-than the currently displayed, is presented on the display of the computing device.

At step 708, the selected data-content is shared from the currently displayed application to an application associated with a user-interface-icon selected from the at least one user-interface-icon.

The steps 702 to 708 are only illustrative and other alternatives can also be provided where one or more steps are added, one or more steps are removed, or one or more steps are provided in a different sequence without departing from the scope of the claims herein. For example, the method 700 can further include rendering a drop-zone for dropping the selected data-content from the currently displayed application therein, prior to presenting the at least one user-interface-icon on the display of the computing device. The method 700 can further include rendering a destination-list associated with the application based on the selected user-interface-icon, and sharing the selected data-content with at least one destination selected from the destination-list.

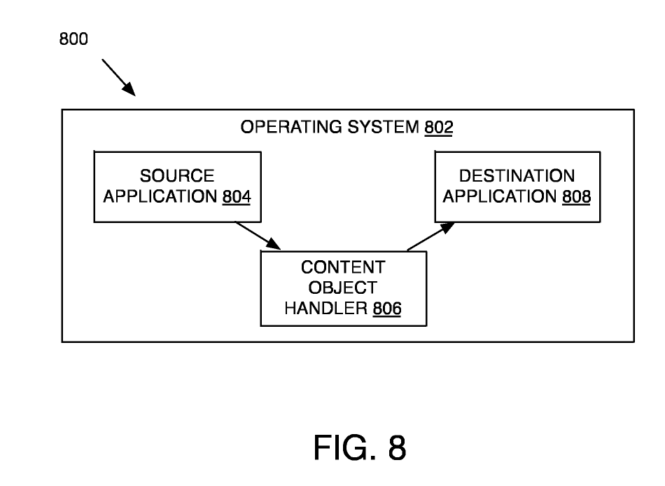

FIG. 8 illustrates the software architecture of the computing device. The key modules are operating system 802, source application 804, content object handler 806, and destination application 808. Operating system 802 may be Android, iOS or similar advanced mobile device operating system. In an embodiment the source application 804 is a web-shop type of application, such as Amazon app distributed from some app store. Such web-shop applications are typically built on top of web-kit functionality. Content object handler 806 may be a background application; its functionalities include recognizing the activation gesture; copying the data content of a data object pressed on the display (the data object being owned by the source application 804); rendering one of the previously presented mechanisms (FIGS. 3,4,5, and 6) associated with the sharing functionality on the computing device display; then activating the (selected) destination application 808 and transferring the content object to the destination application 808. The activation gesture may be dynamically configurable into the content object handler 808 by the user or by another application, such as the source application 804. The activation gesture may thus be any gesture recognised by the user input handlers in the operating system 802, allowing the use of novel input mechanism features, such as Force Touch, voice recognition and gesture recognition using camera. In an embodiment, the destination application 808 is a social media communication application, such as WhatsApp, Facebook or Twitter. The destination application 808 implements a functionality for receiving data objects for further processing. In a preferred embodiment this functionality comprises transferring the data object to a one or more receivers in the social media communication context (for example communicating to friends in the receiver group that the user found an interesting object in the web shop, and shares a link, image of the object).

Content object handler 806 may also be implemented as a module, thread or process of the source application 804. Destination application 808 may be implemented as a module, thread or process of the source application 804.

In an embodiment, the communication device is equipped with a large display, enabling the source application 804 and the destination application 808 be rendered simultaneously on the display. In this case the notification of the availability of the sharing function may be done in a different way, such as rendering the drop-zone on top of the destination application 808.

1. A method for sharing data-content between applications on a display of a computing device, the method comprising:
providing an application to be currently displayed on the display of the computing device;
selecting a data-content from the currently displayed application upon recognizing a pre-determined activation gesture;
presenting at least one user-interface-icon associated with at least one application, other-than the currently displayed, on the display of the computing device; and
sharing the selected data-content from the currently displayed application to an application associated with a user-interface-icon selected from the at least one user-interface-icon.

2. The method of claim 1, further comprising:
rendering a destination-list associated with the application based on the selected user-interface-icon; and
sharing the selected data-content with at least one destination selected from the destination-list.

3. The method of claim 1, wherein the pre-determined activation gesture comprises one of long press, multiple-tap and shaking the computing device.

4. The method of claim 1, further comprising:
rendering a drop-zone for dropping the selected data-content from the currently displayed application therein, prior to presenting the at least one user-interface-icon on the display of the computing device.

5. The method of claim 1, wherein the data-content comprises one of an image, an audio file, a video file, a contact record, a document file, an application file and a web address.

6. A computing device for sharing data-content between applications on a display of the computing device, the computing device comprising a processor operable to:
provide an application to be currently displayed on the display of the computing device;
select a data-content from the application upon recognizing a pre-determined activation gesture;
present at least one user-interface-icon associated with at least one application, other-than the currently displayed, on the display of the computing device; and
share the selected data-content from the currently displayed application to an application associated with a user-interface-icon selected from the at least one user-interface-icon.

7. A system for sharing data-content between applications, the system comprising a source server, at least one destination server and a computing device communicably coupled to the source server and the at least one destination server, the computing device comprising a processor operable to:
provide an application from the source server to be currently displayed on the display of the computing device;
select a data-content from the application upon recognizing a pre-determined activation gesture;
present at least one user-interface-icon associated with at least one application, of the at least one destination server, on the display of the computing device; and
share the selected data-content from the currently displayed application of the source server to an application associated with a user-interface-icon selected from the at least one user-interface-icon.
